(19) United States
(12) Patent Application Publication
(10) Pub. No.: US 2026/0333271 A1
(43) Pub. Date: Oct. 22, 2026

(54) COMMUNICATION METHOD AND APPARATUS, AND DEVICE, STORAGE MEDIUM AND CHIP

(71) Applicant: Beijing Xiaomi Mobile Software Co., Ltd., Beijing (CN)

(72) Inventor: Jinhua WU, Beijing (CN)

(21) Appl. No.: 19/122,829

(22) PCT Filed: Oct. 21, 2022
(86) PCT No.: PCT/CN2022/126826

§ 371 Date: Apr. 21, 2025

(51) Int. Cl. H04W 60/00

(52) U.S. Cl. CPC H04W 60/00

(57) ABSTRACT

A communication method is performed by a user equipment, and includes: sending a registration request to a network device; in response to authorization information fed back by the network device according to the registration request, sending a signaling message to the network device, wherein the signaling message includes a communication status mode of the user equipment; and receiving a signaling response message fed back by the network device according to the signaling message.

### CROSS-REFERENCE TO RELATED APPLICATIONS

This application is a US national stage of International Application No. PCT/CN2022/126826, filed on Oct. 21, 2022, which is hereby incorporated by reference in its entirety.

### TECHNICAL FIELD

The present disclosure relates to the field of communication technologies, and in particular, to a communication method and apparatus, a device, a storage medium, and a chip.

### BACKGROUND

An ambient power-enabled Internet of Things (IoT) device (also referred as zero power consumption IoT) can provide power to the IoT device by harvesting ambient power in some particular use cases. For example, the device can harvest energy from radio waves, or solar energy, and is powered by the harvested energy. However, due to instability of the ambient energy, the IoT device is not always provided with enough energy through ambient power to support lasting wireless communication between the IoT device and mobile networks, hence when considering instability of availability of the IoT device communication, how to support ambient IoT communication in mobile networks is an urgent technical problem to be solved.

### SUMMARY

According to a first aspect of embodiments of the present disclosure, a communication method is provided, performed by a user equipment, including:
sending a registration request to a network device;
in response to authorization information fed back by the network device according to the registration request, sending a signaling message to the network device, where the signaling message includes a communication status mode of the user equipment; and
receiving a signaling response message fed back by the network device according to the signaling message.

According to a second aspect of embodiments of the present disclosure, a communication method is provided, performed by a network device, including:
receiving a registration request sent by a user equipment;
sending authorization information fed back according to the registration request to the user equipment;
receiving a signaling message sent by the user equipment, where the signaling message includes a communication status mode of the user equipment; and
sending a signaling response message fed back according to the signaling message.

In an embodiment, the network device includes a first network element and a second network element. In an example, the first network element includes a radio access network (RAN) network element (also referred to as a RAN device). The second network element includes an access and mobility management function (AMF) network element.

According to a second aspect of embodiments of the present disclosure, a communication method is provided, performed by a radio access network (RAN) device, including:
in response to a registration request sent by a user equipment, sending the registration request to an access and mobility management function (AMF) network element;
in response to a signaling message sent by the user equipment upon receiving authorization information fed back by the AMF network element according to the registration request, sending the signaling message to the AMF network element, where the signaling message includes a communication status mode of the user equipment; and
in response to a signaling response message fed back by the AMF network element according to the signaling message, sending the signaling response message to the user equipment.

According to a third aspect of embodiments of the present disclosure, a communication method is provided, performed by an access and mobility management function (AMF) network element, including:
receiving a registration request sent by a user equipment through a radio access network (RAN) device;
sending authorization information to the user equipment when determining that the user equipment is authorized successfully according to the registration request;
receiving a signaling message sent by the user equipment through the RAN device, where the signaling message includes a communication status mode of the user equipment;
generating a signaling response message according to the signaling message; and
sending the signaling response message to the user equipment through the RAN device.

According to a fourth aspect of embodiments of the present disclosure, a communication apparatus is provided, applied to a user equipment, including:
a first sending module, configured to send a registration request to a network device;
a second sending module, configured to, in response to authorization information fed back by the network device according to the registration request, send a signaling message to the network device, where the signaling message includes a communication status mode of the user equipment; and
a receiving module, configured to receive a signaling response message fed back by the network device according to the signaling message.

According to a fifth aspect of embodiments of the present disclosure, a communication apparatus is provided, applied to a radio access network (RAN) device, including:
a first sending module, configured to, in response to a registration request sent by a user equipment, send the registration request to an access and mobility management function (AMF) network element;
a second sending module, configured to, in response to a signaling message sent by the user equipment upon receiving authorization information fed back by the AMF network element according to the registration request, send the signaling message to the AMF network element, where the signaling message includes a communication status mode of the user equipment; and
a third sending module, configured to, in response to a signaling response message fed back by the AMF network element according to the signaling message, send the signaling response message to the user equipment.

According to a sixth aspect of embodiments of the present disclosure, a communication apparatus is provided, performed by an access and mobility management function (AMF) network element, including:
a first receiving module, configured to receive a registration request sent by a user equipment through a radio access network (RAN) device;
a first sending module, configured to send authorization information to the user equipment when determining that the user equipment is authorized successfully according to the registration request;
a second receiving module, configured to receive a signaling message sent by the user equipment through the RAN device, where the signaling message includes a communication status mode of the user equipment;
a generating module, configured to generate a signaling response message according to the signaling message; and
a second sending module, configured to send the signaling response message to the user equipment through the RAN device.

According to a seventh aspect of the embodiments of the present disclosure, a user equipment is provided, including:
a processor; and
a memory for storing a processor-executable instruction;
where the processor is configured to implement steps of the method according to the first aspect of the present disclosure when executing the executable instruction.

According to an eighth aspect of the embodiments of the present disclosure, a radio access network (RAN) device is provided, including:
a processor; and
a memory for storing a processor-executable instruction;
where the processor is configured to implement steps of the method according to the second aspect of the present disclosure when executing the executable instruction.

According to a ninth aspect of embodiments of the present disclosure, an access and mobility management function (AMF) network element is provided, including:
a processor; and
a memory for storing a processor-executable instruction;
where the processor is configured to implement steps of the method according to the third aspect of the present disclosure when executing the executable instruction.

According to a tenth aspect of the embodiments of the present disclosure, a computer-readable storage medium is provided, storing a computer program instruction, where when the program instruction is executed by a processor, steps of the method according to any one of the first aspect of the present disclosure is implemented; or when the program instruction is executed by a processor, steps of the method according to any one of the second aspect of the present disclosure is implemented; or when the program instruction is executed by a processor, steps of the method according to any one of the third aspect of the present disclosure is implemented.

According to an eleventh aspect of the embodiments of the present disclosure, a chip is provided, including a processor and an interface, where the processor is configured to read an instruction to perform the method according to any one of the first aspect of the present disclosure; or the processor is configured to read an instruction to perform the method according to any one of the second aspect of the present disclosure; or the processor is configured to read an instruction to perform the method according to any one of the third aspect of the present disclosure.

In the above technical solutions, a registration request is sent to a network device; in response to authorization information fed back by the network device according to the registration request, a signaling message is sent to the network device, where the signaling message includes a communication status mode of the user equipment; and a signaling response message fed back by the network device according to the signaling message is received. Therefore, the user equipment reports the communication status mode to an AMF network element, so as to determine the communication availability of the user equipment, such that the AMF network element performs mobile communication with the user equipment by means of the communication availability, thereby implementing on-demand communication between the user equipment and a mobile network.

### BRIEF DESCRIPTION OF DRAWINGS

The accompanying drawings, which are incorporated in and constitute a part of this specification, illustrate embodiments consistent with the present disclosure and together with the description serve to describe the principles of the present disclosure.

FIG. 1 is a flowchart of a communication method according to an example embodiment.

FIG. 2 is a schematic diagram of a wireless network system architecture of an ambient Internet of Things according to an example embodiment.

FIG. 3 is a flowchart of a communication method according to an example embodiment.

FIG. 4 is a flowchart of a communication method according to an example embodiment.

FIG. 5 is a flowchart of a communication method according to an example embodiment.

FIG. 6 is a flowchart of a communication method according to an example embodiment.

FIG. 7 is a flowchart of a communication method according to an example embodiment.

FIG. 8 is a flowchart of a communication method according to an example embodiment.

FIG. 9 is a flowchart of a communication method according to an example embodiment.

FIG. 10 is a flowchart of a communication method according to an example embodiment.

FIG. 11 is a flowchart of a communication method according to an example embodiment.

FIG. 12 is a flowchart of a communication method according to an example embodiment.

FIG. 13 is a flowchart of a communication method according to an example embodiment.

FIG. 14 is a block diagram of a communication apparatus according to an example embodiment.

FIG. 15 is a block diagram of a communication apparatus according to an example embodiment.

FIG. 16 is a block diagram of a communication apparatus according to an example embodiment.

FIG. 17 is a block diagram of a communication apparatus according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the present disclosure. Rather, they are merely examples of apparatuses and methods consistent with some aspects of the present disclosure as detailed in the appended claims.

It may be understood that “a plurality of” in the present disclosure refers to two or more, and other quantifiers are similar thereto. “And/or” describes an association relationship of associated objects, indicating that there may be three relationships, for example, A and/or B may represent three cases: A alone, A and B together, and B alone. The character “/” generally indicates that the associated objects are in an “or” relationship. The singular forms “a”, “the”, and “said” are also intended to include plural forms unless the context clearly indicates otherwise.

It should be further understood that although the operations are described in a specific order in the drawings in the embodiments of the present disclosure, it should not be understood that the operations are required to be performed in the specific order shown or in the serial order, or all the shown operations are required to be performed to obtain a desired result. In certain circumstances, multitasking and parallel processing may be advantageous.

It should be noted that all actions of obtaining signals, information or data in the present disclosure are performed on the premise of conforming to a corresponding data protection regulation policy of a country at which the terminal is located, and obtaining authorization given by a corresponding device owner.

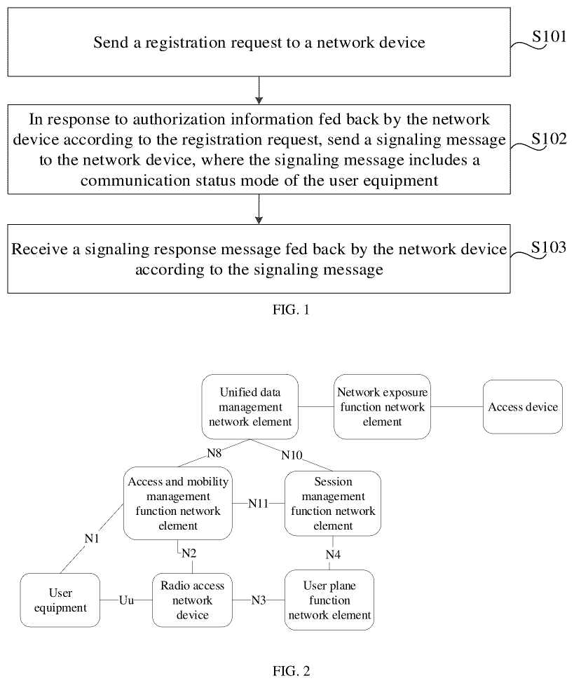

FIG. 1 is a flowchart of a communication method according to an example embodiment. As shown in FIG. 1, the method is performed by a user equipment, and the method includes steps S101-S103.

In step S101, sending a registration request to a network device.

For example, this embodiment is performed by the UE, the UE is an Internet of Things device, which can communicate with a mobile network without any conventional power supply, by which manual intervention to charge or replace a battery is avoided, and the UE can use energy harvested from radio waves or any other form of energy that can be obtained under a specific use condition, and convert the energy into power of the UE. For example, the radio wave may be from a wireless network entity or another UE, and other forms of energy may be solar energy, optical energy, mechanical kinetic energy, thermal energy, pressure, etc. The UE may be applied to the following multiple scenarios:

### (1) IWSN (Industrial Wireless Sensor Network)

IWSN has been widely deployed in entity manufacturing scenarios, and energy harvesting can be provided for IWSN by the entity manufacturing scenarios, to enable the UE to achieve more application functions. In the IWSN application, the environments are harsh with high/low temperature, moving or rotation parts, high vibration conditions, humidity and other hazardous conditions, which requires the UE to be maintenance-free, battery-less, ultra-low power and with long service life.

### (2) Smart Logistics and Smart Warehousing

In logistics and warehousing cases, huge amount of goods needs to be frequently transferred, stored, loaded/unloaded, and inventoried in the logistic station or warehouse (tens of thousands of m2). Ambient power-enabled IoT can achieve smart logistics and smart warehousing with its features of extremely-low cost, small form factor, maintenance-free, durability, long life span, etc.

### (3) Smart Home Network

Ambient power-enabled IoT can also be applied to house hold items managements, wearables, and environment (temperature, humidity etc.) monitoring due to its characteristics of ultra-low cost, very small form factor, washable, flexible/foldable form factor and very long-lifetime.

### (4) Smart Agriculture

Ambient power-enabled IoT would also benefit smart agriculture. For example, ambient power-enabled IoT devices driven by solar can be used to monitor the soil moisture, soil fertility, the temperature, wind speed, plant growth, etc. In addition, the devices can also be used to control the agricultural facilities such as irrigation system. For smart agriculture, the ambient power-enabled IoT devices need to be widely deployed in the farm with sufficient density. Usually there would be no conventional electric power supply for the communication system and the ambient power-enabled IoT device cannot use conventional battery due to its operating circumstance and the requirements of long-life span etc. Therefore, energy harvested from solar can be an alternative to drive the communication system and the devices to popularize its applications.

In the above application scenario, power of the UE is mainly derived from the energy in the environment, but the energy in the environment is affected by a plurality of factors, and has a characteristic of instability, and in some application scenarios, a situation that the power cannot be continuously provided for the UE due to low energy in the environment may occur. For example, in the application scenario of the above smart agriculture, for the UE powered by absorbing solar energy, in cloudy or rainy weather, the UE cannot absorb solar energy from environment, which will cause that the UE is powered off and cannot communicate with the mobile network. However, the mobile network cannot implement on-demand communication of the UE according to current communication availability of the UE, so a communication method is provided in this embodiment to support ambient Internet of Things communication in the mobile network.

For example, FIG. 2 is a schematic diagram of a wireless network system architecture of an ambient Internet of Things according to an example embodiment, as shown in FIG. 2, the system architecture includes a UE and a network device, and the network device may include a radio access network (RAN) device, a user plane function (UPF) network element, an access and mobility management function (AMF) network element, a session management function (SMF) network element, a unified data management (UDM) network element, a network exposure function (NEF) network element, and access facilities (AF). The UE in this embodiment is connected to the network device through the above system architecture, to implement wireless communication between the UE and the network device. When the UE establishes communication interaction with the network device for the first time, the UE needs to send a registration request to the network device for registration, and the network device determines, based on the registration request, whether to authorize communication interaction with the UE.

Optionally, the registration request includes registration type information, user identifier information, and security parameter information.

For example, in this embodiment, when the UE sends the registration request to the network device, the registration request includes registration type information, user identifier information, and security parameter information, so that the network device judges the registration request of the UE based on the related information in the registration request, and determines whether the UE can be authorized to be registered, for example, the network device may determine, based on the user identifier information, whether the UE has a legal identity; and determine, based on the registration type information, whether to establish a corresponding type of communication service with the UE; and determine, based on the security parameter information, whether the communication interaction with the UE is secure, so as to determine, based on the related information in the registration request, whether to authorize to establish a communication interaction with the UE.

Optionally, the user identifier information includes at least one of: a subscription concealed identifier (SUCI), a globally unique temporary user equipment identity (GUTI), or a permanent equipment identity (PEI).

For example, in this embodiment, the user identifier information corresponding to the UE may include at least one of: a subscription concealed identifier (SUCI), a globally unique temporary user equipment identity (GUTI), or a permanent equipment identity (PEI), and the network device may determine a unique identifier of the UE through the user identifier information, and determine, based on the identifier, whether to authorize communication interaction with the UE.

In step S102, in response to authorization information fed back by the network device according to the registration request, sending a signaling message to the network device, where the signaling message includes a communication status mode of the user equipment.

For example, in this embodiment, the network device performs communication authorization determination on the UE through the registration request, and feeds back authorization information to the UE when the UE is authorized to establish communication interaction, so as to feed back authorization success to the UE based on the authorization information. After receiving the authorization information, the UE sends a signaling message to the network device, where the signaling message indicates a communication status mode of the UE. It should be noted that, in this embodiment, the UE is an Internet of Things device which is powered by harvesting energy from an environment, and due to instability of the ambient energy, a communication status mode of the UE fluctuates, so that the UE needs to report a current communication status mode of the UE to a mobile network, so that a network device adjusts a communication manner with the UE according to the communication status mode of the UE, thereby implementing on-demand communication and avoiding unnecessary communication overheads. In this embodiment, after a communication connection is established between the UE and the network device for the first time, a communication status mode of the UE needs to be sent to the network device, and the network device performs wireless communication in different manners with the UE according to different communication status modes. For example, the UE sends the current communication status mode of the UE to the network device when the communication status mode changes based on the communication status mode sent to the network device during registration.

Optionally, the communication status mode includes an ordinary communication mode, a receiver communication mode, or a dormant communication mode.

For example, in an ordinary communication mode, the UE can send signaling and data to the network device, and can receive the signaling and data sent by the network device. For example, when the UE is able to acquire sufficient energy from the environment, the communication status mode of the UE may be an ordinary communication mode. For another example, in the receiver communication mode, the UE can receive signaling and data sent by the network device, but the UE cannot send the signaling and data to the network device. For example, when the UE acquires certain amount of energy from the environment, the communication status mode of the UE may be a receiver communication mode. For another example, in the dormant communication mode, the UE cannot send signaling and data to the network device, and cannot receive signaling and data sent by the network device. For example, when the UE cannot support the UE to stay in the ordinary communication mode or the receiver communication mode due to insufficient energy harvested from the environment, the communication status mode of the UE may be the dormant communication mode.

In step S103, receiving a signaling response message fed back by the network device according to the signaling message.

For example, in this embodiment, after receiving the signaling message sent by the UE, the network device determines the communication manner with the UE according to the signaling message, and generates a signaling response message based on the signaling message. The network device sends the signaling response message to the UE. The signaling response message indicates to the UE that the network device has received the communication status mode of the UE, and establishes communication with the UE according to the communication status mode; and the UE performs communication interaction with the network device according to the communication status mode corresponding to the signaling response message. For example, after receiving the signaling message of the UE, the network device stores the communication status mode, and processes communication with the UE according to the communication status mode after sending the signaling response message.

In the above manner, the UE reports the communication status mode to the network device through the signaling message, and the network device feeds back corresponding a signaling response message to the UE according to the communication status mode, and establishes communication with the UE based on the communication status mode. Therefore, the UE reports communication availability of the UE to the network device, to implement on-demand communication of the UE, and ambient Internet of Things communication in the mobile network is supported.

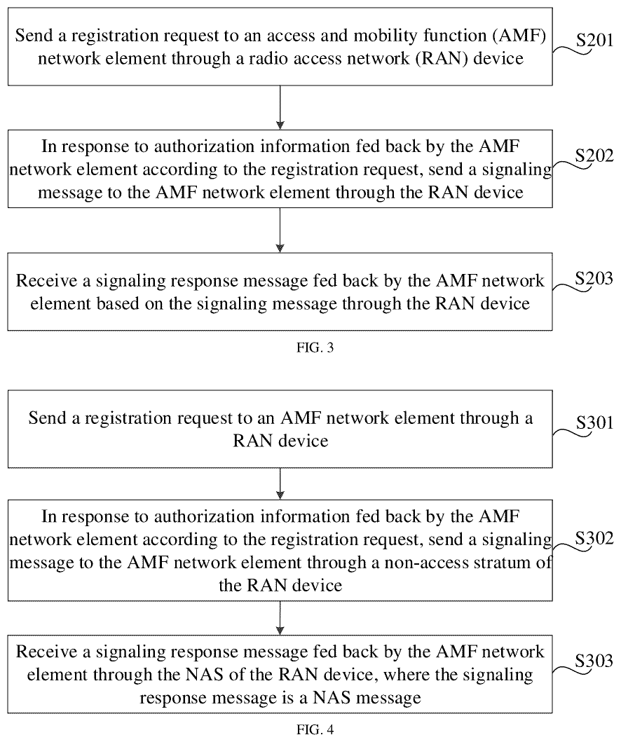

FIG. 3 is a flowchart of a communication method according to an example embodiment. As shown in FIG. 3, the method is performed by a user equipment, and the method includes following steps.

In an embodiment, the network device includes a RAN device and an AMF network element, and sending the registration request to the network device includes:

In step S201, sending the registration request to the AMF network element through the RAN device.

For example, the UE in this embodiment is connected to the mobile network through the above system architecture, and the UE may be connected to the AMF network element through the N1 interface, or connected to the RAN device through the Uu interface, so as to implement wireless communication between the UE and the mobile network. When the UE establishes communication interaction with the AMF network element for the first time, the UE needs to send a registration request to the AMF network element through the RAN device to perform registration, and the AMF network element determines, based on the registration request, whether to authorize communication interaction with the UE.

In another embodiment, sending the signaling message to the network device in response to the authorization information fed back by the network device according to the registration request includes:

In step S202, in response to authorization information fed back by the AMF network element according to the registration request, sending a signaling message to the AMF network element through the RAN device, where the signaling message includes a communication status mode of the user equipment.

For example, in this embodiment, the AMF network element performs communication authorization determination on the UE through the registration request, and feeds back authorization information to the UE when the UE is authorized to establish communication interaction, so as to feed back authorization success to the UE based on the authorization information. After receiving the authorization information, the UE sends a signaling message to the AMF network element through the RAN device, where the signaling message indicates the communication status mode of the UE. It should be noted that, in this embodiment, the UE is an Internet of Things device which is powered by harvesting energy from an environment, and due to instability of the ambient energy, a communication status mode of the UE fluctuates, so that the UE needs to report a current communication status mode of the UE to a mobile network, so that the AMF network element adjusts a communication manner with the UE according to the communication status mode of the UE, thereby implementing on-demand communication and avoiding unnecessary communication overheads. In this embodiment, after a communication connection is established between the UE and the AMF network element for the first time, the communication status mode of the UE needs to be sent to the AMF network element, and the AMF network element performs wireless communication with the UE in different manners based on different communication status modes. For example, when the communication status mode changes, the UE sends the current communication status mode of the UE to the AMF network element through the RAN device based on a communication status mode sent to the AMF network element during registration.

In another embodiment, receiving a signaling response message fed back by the network device based on the signaling message includes:

In step S203, receiving a signaling response message fed back by the AMF network element based on the signaling message through the RAN device.

For example, in this embodiment, after receiving the signaling message sent by the UE, the AMF network element determines the communication manner with the UE according to the signaling message, and generates a signaling response message based on the signaling message. The AMF network element sends the signaling response message to the UE through the RAN device. The signaling response message indicates to the UE that the AMF network element has received the communication status mode of the UE, and establishes communication with the UE based on the communication status mode; the UE performs communication interaction with the AMF network element based on the communication status mode corresponding to the signaling response message; for example, after receiving the signaling message of the UE, the RAN device stores the communication status mode of the UE, and processes communication with the UE based on the communication status mode after receiving the signaling response message; and after receiving the signaling message of the UE, the AMF network element stores the communication status mode of the UE, and processes communication with the UE based on the communication status mode after sending the signaling response message.

In the above manner, the UE reports the communication status mode to the AMF network element through the signaling message, and the AMF network element feeds back corresponding a signaling response message to the UE according to the communication status mode, and establishes communication with the UE based on the communication status mode. Therefore, the UE reports communication availability of the UE to the AMF network element, to implement on-demand communication of the UE, and ambient Internet of Things communication in the mobile network is supported.

FIG. 4 is a flowchart of a communication method according to an example embodiment, as shown in FIG. 4, the method is performed by a UE, and the method includes following steps.

In step S301, sending a registration request to an AMF network element through a RAN device.

For example, a manner of sending the registration request in this embodiment is same as that in step S201, thus step S201 can be referred to and details will not be repeated herein.

In an embodiment, the step of in response to authorization information fed back by the AMF network element according to the registration request, sending the signaling message to the AMF network element through the RAN device, where the signaling message includes a communication status mode of the user equipment includes:

In step S302, in response to authorization information fed back by the AMF network element according to the registration request, sending the signaling message to the AMF network element through a non-access stratum of the RAN device, where the signaling message includes a communication status mode of the user equipment.

For example, in this embodiment, a communication connection is established between the UE and the RAN device, the signaling message is sent to the RAN device through a non-access stratum (NAS) of the RAN device, and then the signaling message is sent to the AMF network element through a NAS between the RAN device and the AMF network element. The signaling message is a NAS message, the NAS message is clear for the RAN device, and the RAN device directly sends the NAS message to the AMF network element without determining content in the NAS message.

In another embodiment, receiving the signaling response message fed back by the AMF network element according to the signaling message through the RAN device includes:

In step S303, receiving the signaling response message fed back by the AMF network element through the NAS of the RAN device, where the signaling response message is a NAS message.

For example, in this embodiment, a manner for the AMF network element to generate the signaling response message based on the signaling message is same as that in step S203, hence step S203 can be referred to and details will not be repeated herein. After generating the signaling response message based on the signaling message, the AMF network element sends the signaling response message to the RAN device through the NAS of the RAN device, and the RAN device feeds back the signaling response message to the UE through the NAS. The function of the signaling response message is same as that in step S203, reference may be made to step S203, and details will not be repeated herein.

In the above manner, the UE reports the communication status mode to the AMF network element through the NAS of the RAN device through the signaling message, and the AMF network element feeds back corresponding a signaling response message to the UE based on the communication status mode, and establishes communication with the UE based on the communication status mode. Therefore, the UE reports communication availability of the UE to the AMF network element, to implement on-demand communication of the UE, and ambient Internet of Things communication in the mobile network is supported.

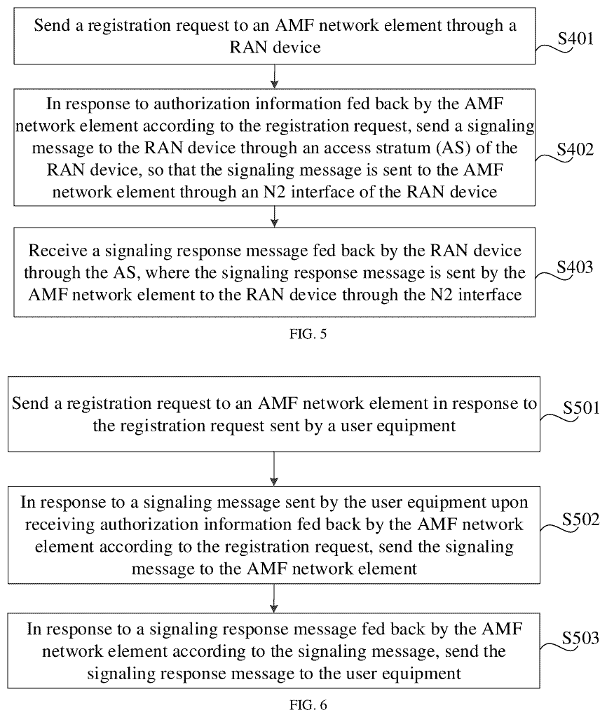

FIG. 5 is a flowchart of a communication method according to an example embodiment, as shown in FIG. 5, the method is performed by a UE, and the method includes following steps.

In step S401, sending a registration request to an AMF network element through a RAN device.

For example, a manner of sending the registration request in this embodiment is same as that in step S201, thus step S201 can be referred to and details will not be repeated herein.

In an embodiment, the step of in response to authorization information fed back by the AMF network element according to the registration request, sending the signaling message to the AMF network element through the RAN device, where the signaling message includes a communication status mode of the user equipment includes:

In step S402, in response to the authorization information fed back by the AMF network element according to the registration request, sending a signaling message to the RAN device through an access stratum (AS) of the RAN device, so that the signaling message is sent to the AMF network element through an N2 interface of the RAN device, where the signaling message includes the communication status mode of the user equipment.

For example, in this embodiment, a communication connection is established between the UE and the RAN device, the signaling message is sent to the RAN device through an access stratum (AS) of the RAN device, the RAN device parses the signaling message, determines a corresponding AMF network element, and sends the signaling message to the AMF network element through an N2 interface between the RAN device and the AMF network element.

In another embodiment, receiving the signaling response message fed back by the AMF network element according to the signaling message through the RAN device includes:

In step S403, receiving a signaling response message fed back by the RAN device through the AS, where the signaling response message is sent by the AMF network element to the RAN device through the N2 interface.

For example, in this embodiment, a manner for the AMF network element to generate the signaling response message based on the signaling message is same as that in step S203, hence step S203 can be referred to and details will not be repeated herein. In this embodiment, after generating the signaling response message according to the signaling message, the AMF network element sends the signaling response message to the RAN device through the N2 interface between the AMF network element and the RAN device, and after parsing the signaling response message to determine the corresponding UE, the RAN device sends the signaling response message to the UE through the AS, where a function of the signaling response message is same as that in step S203, reference may be made to step S203, and details will not be repeated herein.

In the above manner, the UE reports the communication status mode through the AS of the RAN device based on the signaling message, reports the communication status mode to the AMF network element through the N2 interface between the RAN device and the AMF network element, and the AMF network element feeds back corresponding a signaling response message to the UE based on the communication status mode, and establishes communication with the UE based on the communication status mode. Therefore, the UE reports communication availability of the UE to the AMF network element, to achieve on-demand communication of the UE, and ambient Internet of Things communication in the mobile network is supported.

FIG. 6 is a flowchart of a communication method according to an example embodiment. As shown in FIG. 6, the method is performed by a radio access network (RAN) device, and the method includes following steps.

In step S501, sending a registration request to an AMF network element in response to the registration request sent by a user equipment.

For example, a manner of sending the registration request in this embodiment is same as that in step S201, thus step S201 can be referred to and details will not be repeated herein.

Optionally, the registration request includes registration type information, user identifier information, and security parameter information.

For example, a definition of the registration request in this embodiment is same as that in step S201, thus step S201 can be referred to and details will not be repeated herein.

Optionally, the user identifier information includes at least one of: a subscription concealed identifier (SUCI), a globally unique temporary user equipment identity (GUTI), or a permanent equipment identity (PEI).

For example, a definition of the user identifier information in this embodiment is same as that in step S201, thus step S201 can be referred to and details will not be repeated herein.

In step S502, in response to a signaling message sent by the user equipment upon receiving authorization information fed back by the AMF network element according to the registration request, sending the signaling message to the AMF network element, where the signaling message includes a communication status mode of the user equipment.

For example, a manner of sending the signaling message in this embodiment is same as that in step S202, thus step S202 can be referred to and details will not be repeated herein.

Optionally, the communication status mode includes an ordinary communication mode, a receiver communication mode, or a dormant communication mode.

For example, a definition of the communication status mode in this embodiment is same as that in step S202, thus step S202 can be referred to and details will not be repeated herein.

In step S503, in response to a signaling response message fed back by the AMF network element according to the signaling message, sending the signaling response message to the user equipment.

For example, a manner of sending the signaling response message in this embodiment is same as that in step S203, thus step S203 can be referred to and details will not be repeated herein.

Optionally, in an embodiment, after step S503, the communication method further includes:
in response to receiving the signaling response message, transmitting communication data between the RAN device and the user equipment.

For example, in this embodiment, after receiving the signaling response message, the RAN device performs communication interaction with the UE as indicated by the signaling response message.

Optionally, in another embodiment, transmitting communication data between the RAN device and the user equipment in response to receiving a signaling response message includes:
determining a target communication status mode of the user equipment according to the signaling response message;
when the target communication status mode is an ordinary communication mode, receiving and/or sending the communication data with the user equipment;
when the target communication status mode is a receiver communication mode, sending the communication data with the user equipment; and
when the target communication status mode is a dormant communication mode, forbidding receiving and/or sending the communication data with the user equipment.

For example, in this embodiment, after receiving the signaling response message from the AMF network element, the RAN device determines the communication status mode of the UE according to the signaling response message, determines the communication manner between the RAN device and the UE based on the communication status mode, and processes the communication data between the RAN device and the UE based on the communication manner. For example, when the communication status mode of the UE is an ordinary communication mode, the RAN device considers the UE as an ordinary communication device to receive or send signaling and data; when the communication status mode of the UE is a receiver communication mode, the RAN device considers the UE as a receiving device to only send signaling and data to the UE; and when the communication status mode of the UE is a dormant communication mode, communication between the RAN device and the UE stops, and the RAN device cannot send or receive signaling and data with the UE.

In the above manner, the RAN device sends the communication status mode of the UE to the AMF network element, so that the AMF network element feeds back corresponding a signaling response message to the UE according to the communication status mode, and establishes communication with the UE based on the communication status mode. Therefore, the UE reports communication availability of the UE to the AMF network element, to implement on-demand communication of the UE, and ambient Internet of Things communication in the mobile network is supported.

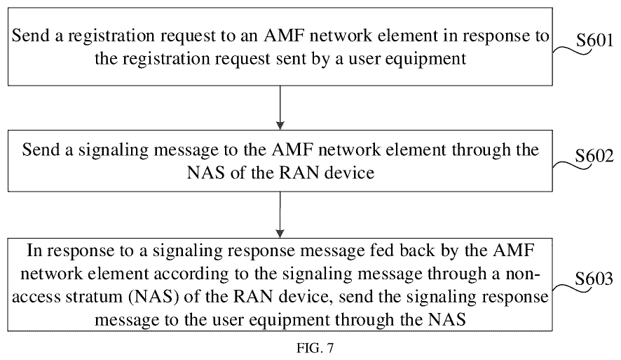

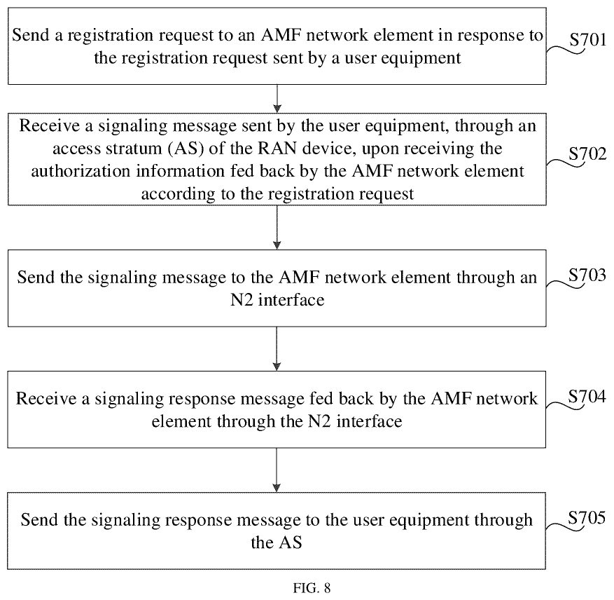

FIG. 7 is a flowchart of a communication method according to an example embodiment. As shown in FIG. 7, the method is performed by a radio access network (RAN) device, and the method includes following steps.

In step S601, sending a registration request to an AMF network element in response to the registration request sent by a user equipment.

For example, a manner of sending the registration request in this embodiment is same as that in steps S201 and S501, thus steps S201 and S501 can be referred to and details will not be repeated herein.

In an embodiment, the step of in response to a signaling message sent by the user equipment upon receiving authorization information fed back by the AMF network element according to the registration request, sending the signaling message to the AMF network element includes:

In step S602, sending a signaling message to the AMF network element through the NAS of the RAN device.

For example, a manner of sending the signaling message through the NAS in this embodiment is same as that in step S302, thus step S302 can be referred to and details will not be repeated herein.

In another embodiment, the step of in response to a signaling response message fed back by the AMF network element according to the signaling message, sending the signaling response message to the user equipment includes:

In step S603, in response to the signaling response message fed back by the AMF network element according to the signaling message through a non-access stratum (NAS) of the RAN device, sending the signaling response message to the user equipment through the NAS.

For example, a manner of sending the signaling response message in this embodiment is same as that in step S303, thus step S303 can be referred to and details will not be repeated herein.

In the above manner, the UE reports the communication status mode to the AMF network element through the NAS of the RAN device through the signaling message, and the AMF network element feeds back corresponding a signaling response message to the UE based on the communication status mode, and establishes communication with the UE based on the communication status mode. Therefore, the UE reports communication availability of the UE to the AMF network element, to implement on-demand communication of the UE, and ambient Internet of Things communication in the mobile network is supported.

FIG. 8 is a flowchart of a communication method according to an example embodiment. As shown in FIG. 8, the method is performed by a radio access network (RAN) device, and the method includes following steps.

In step S701, sending a registration request to an AMF network element in response to the registration request sent by a user equipment.

For example, a manner of sending the registration request in this embodiment is same as that in steps S201 and S501, thus steps S201 and S501 can be referred to and details will not be repeated herein.

In an embodiment, the step of in response to a signaling message sent by the user equipment upon receiving authorization information fed back by the AMF network element according to the registration request, sending the signaling message to the AMF network element includes steps S702 and S703.

In step S702, receiving the signaling message sent by the user equipment, through an access stratum (AS) of the RAN device, upon receiving the authorization information fed back by the AMF network element according to the registration request.

For example, a manner of sending the signaling message through the AS in this embodiment is same as that in step S402, thus step S402 can be referred to and details will not be repeated herein.

In step S703, sending the signaling message to the AMF network element through the N2 interface.

For example, a manner of sending the signaling message through the N2 interface in this embodiment is same as that in step S402, thus step S402 can be referred to and details will not be repeated herein.

In an embodiment, the step of in response to a signaling response message fed back by the AMF network element according to the signaling message, sending the signaling response message to the user equipment includes steps S704 and S705.

In step S704, receiving a signaling response message fed back by the AMF network element through the N2 interface.

For example, a manner of receiving the signaling response message through the N2 interface in this embodiment is same as that in step S402, thus step S402 can be referred to and details will not be repeated herein.

In step S705, sending the signaling response message to the user equipment through the AS.

For example, a manner of sending the signaling response message through the AS in this embodiment is same as that in step S402, thus step S402 can be referred to and details will not be repeated herein. It should be noted that, usually, after receiving the signaling response message sent by the AMF network element, the RAN device needs to feed back communication information to the AMF network element, the AMF network element feeds back an acknowledgment to the RAN device through the communication information, and after receiving the acknowledgment, the RAN device feeds back the signaling response message through the AS. In this embodiment, to improve transmission efficiency of the communication data, after receiving the signaling response message, the RAN device does not need to wait the acknowledgement character from the AMF network element, but sends the signaling response message directly to the UE.

Optionally, in another embodiment, step S705 includes:
sending the signaling response message to the user equipment through the AS in response to an acknowledgement character (ACK) sent by the AMF network element.

For example, in this embodiment, after receiving the signaling response message sent by the AMF network element, the RAN device needs to feed back communication information to the AMF network element, where the communication information is used to inform the AMF network element that the RAN device has received the signaling response message, and after receiving the communication information, the AMF network element controls, through ACK (acknowledgement character), an occasion at which the RAN device sends the signaling response message; when determining that the signaling response message needs to be sent to the UE, the AMF network element generates the ACK based on the communication information, and sends the ACK to the RAN device; and the RAN device sends the signaling response message to the UE through the AS in response to the ACK.

In the above manner, the UE reports the communication status mode through the AS of the RAN device based on the signaling message, reports the communication status mode to the AMF network element through the N2 interface between the RAN device and the AMF network element, and the AMF network element feeds back corresponding a signaling response message to the UE based on the communication status mode, and establishes communication with the UE based on the communication status mode. Therefore, the UE reports communication availability of the UE to the AMF network element, to implement on-demand communication of the UE, and ambient Internet of Things communication in the mobile network is supported.

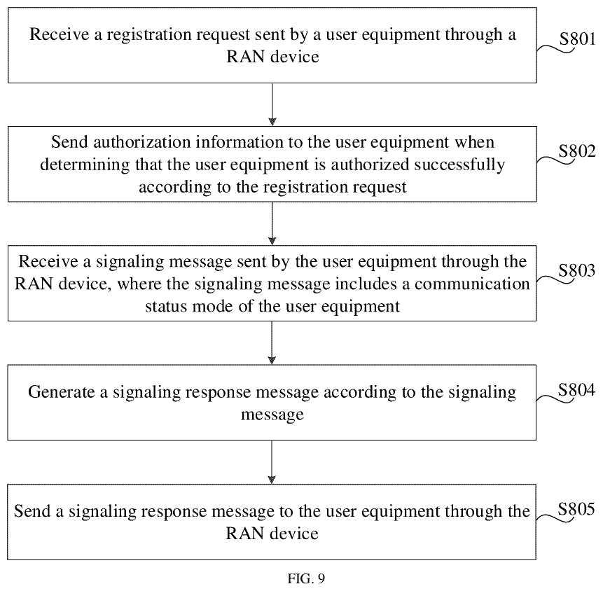

FIG. 9 is a flowchart of a communication method according to an example embodiment. As shown in FIG. 9, the method is performed by an access and mobility management function (AMF) network element, and the method includes following steps.

In step S801, receiving a registration request sent by a user equipment through a RAN device.

For example, a manner of receiving the registration request in this embodiment is same as that in step S201, thus step S201 can be referred to and details will not be repeated herein.

Optionally, the registration request includes registration type information, user identifier information, and security parameter information.

For example, a definition of the registration request in this embodiment is same as that in step S201, thus step S201 can be referred to and details will not be repeated herein.

Optionally, the user identifier information includes at least one of: a subscription concealed identifier (SUCI), a globally unique temporary user equipment identity (GUTI), or a permanent equipment identity (PEI).

In step S802, sending authorization information to the user equipment when determining that the user equipment is authorized successfully according to the registration request.

For example, a manner of sending the authorization information in this embodiment is same as that in step S201, thus step S201 can be referred to and details will not be repeated herein.

In step 803, receiving a signaling message sent by the user equipment through the RAN device, where the signaling message includes a communication status mode of the user equipment.

For example, a manner of receiving the signaling message in this embodiment is same as that in step S202, thus step S202 can be referred to and details will not be repeated herein.

Optionally, the communication status mode includes an ordinary communication mode, a receiver communication mode, or a dormant communication mode.

For example, a definition of the communication status mode in this embodiment is same as that in step S202, thus step S202 can be referred to and details will not be repeated herein.

In step S804, generating a signaling response message according to the signaling message.

For example, in this embodiment, a manner of generating the signaling response message is same as that in step S203, hence step S203 can be referred to and details will not be repeated herein.

In step S805, sending the signaling response message to the user equipment through the RAN device.

For example, a manner of sending the signaling response message in this embodiment is same as that in step S203, thus step S203 can be referred to and details will not be repeated herein.

Optionally, the communication method further includes:

transmitting communication data between the AMF network element and/or another core network node and the user equipment according to the signaling response message.

For example, in this embodiment, after generating the signaling response message, the signaling response message indicates the AMF network element and/or another core network node to perform communication interaction with the UE.

Optionally, in another embodiment, the step of transmitting, according to the signaling response message, communication data between the AMF network element and/or another core network node and the user equipment includes:
determining a target communication status mode of the user equipment according to the signaling response message;
when the target communication status mode is an ordinary communication mode, receiving and/or sending the communication data with the user equipment;
when the target communication status mode is a receiver communication mode, sending the communication data with the user equipment; and
when the target communication status mode is a dormant communication mode, forbidding receiving and/or sending the communication data with the user equipment.

For example, in this embodiment, the AMF network element generates a signaling response message corresponding to the UE through the above steps, and determines, based on the signaling response message, a communication manner between the AMF network element and another core network node and the UE, so that the AMF network element and the other core network element node process communication with the UE based on the communication manner. For example, when it is determined, according to the signaling response message, that the communication manner is an ordinary communication manner, the UE is an ordinary communication device, and the AMF network element and the other core network node may send or receive signaling and data to the UE; when it is determined, according to the signaling response message, that the communication manner is receiving-only communication manner, the UE is a receiving device, and the AMF network element and the other core network node can only send signaling and data to the UE; or when it is determined, according to the signaling response message, that the communication manner is a dormant communication manner, communication with the UE is stopped, and the AMF network element and the other core network node cannot send or receive signaling and data to the UE.

In the above manner, the AMF network element receives the signaling message of the UE to determine the communication status mode of the UE, and feeds back corresponding a signaling response message to the UE according to the communication status mode, and establishes communication with the UE based on the communication status mode. Therefore, the UE reports communication availability of the UE to the AMF network element, to implement on-demand communication of the UE, and ambient Internet of Things communication in the mobile network is supported.

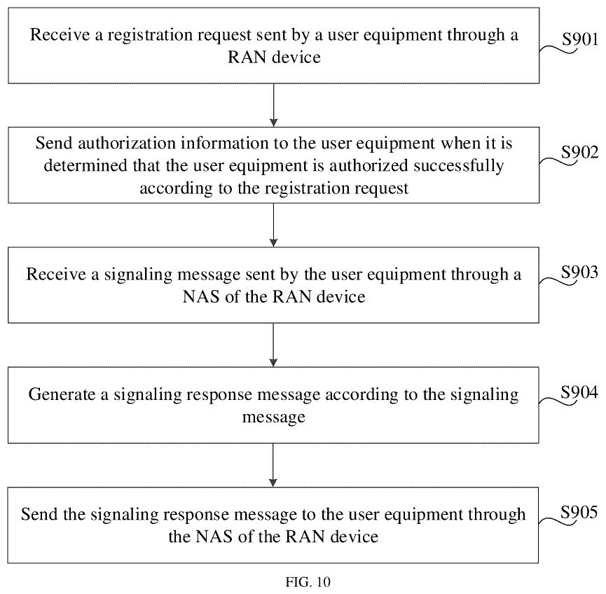

FIG. 10 is a flowchart of a communication method according to an example embodiment. As shown in FIG. 10, the method is performed by an access and mobility management function (AMF) network element, and the method includes following steps.

In step S901, receiving a registration request sent by a user equipment through a RAN device.

For example, a manner of receiving the registration request in this embodiment is same as that in step S801, thus step S801 can be referred to and details will not be repeated herein.

In step S902, sending authorization information to the user equipment when it is determined that the user equipment is authorized successfully according to the registration request.

For example, a manner of sending the authorization information in this embodiment is same as that in step S802, thus step S802 can be referred to and details will not be repeated herein.

In an embodiment, the step of receiving the signaling message sent by the user equipment through the RAN device includes:

In step S903, receiving the signaling message sent by the user equipment through a NAS of the RAN device.

For example, a manner of receiving the signaling message in this embodiment is same as that in step S302, thus step S302 can be referred to and details will not be repeated herein.

In step S904, generating a signaling response message according to the signaling message.

For example, in this embodiment, a manner of generating the signaling response message is same as that in step S804, hence step S804 can be referred to and details will not be repeated herein.

In another embodiment, the step of sending the signaling response message to the user equipment through the RAN device includes:

In step S905, sending the signaling response message to the user equipment through the NAS of the RAN device.

For example, a manner of sending the signaling response message in this embodiment is same as that in step S303, thus step S303 can be referred to and details will not be repeated herein.

In the above manner, the UE reports the communication status mode to the AMF network element through the NAS of the RAN device through the signaling message, and the AMF network element feeds back corresponding a signaling response message to the UE based on the communication status mode, and establishes communication with the UE based on the communication status mode. Therefore, the UE reports communication availability of the UE to the AMF network element, to implement on-demand communication of the UE, and ambient Internet of Things communication in the mobile network is supported.

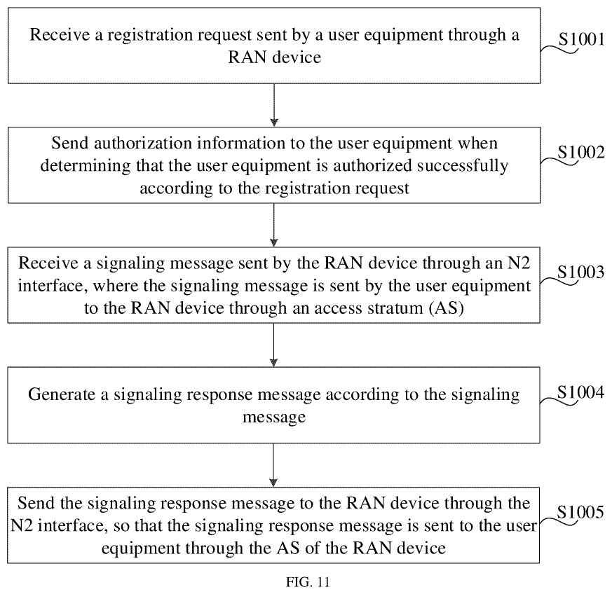

FIG. 11 is a flowchart of a communication method according to an example embodiment. As shown in FIG. 11, the method is performed by an access and mobility management function (AMF) network element, and the method includes following steps.

In step S1001, receiving a registration request sent by a user equipment through a RAN device.

For example, a manner of receiving the registration request in this embodiment is same as that in step S801, thus step S801 can be referred to and details will not be repeated herein.

In step S1002, sending authorization information to the user equipment when determining that the user equipment is authorized successfully according to the registration request.

For example, a manner of sending the authorization information in this embodiment is same as that in step S802, thus step S802 can be referred to and details will not be repeated herein.

In an embodiment, the step of receiving the signaling message sent by the user equipment through the RAN device includes:

In step S1003, receiving the signaling message sent by the RAN device through an N2 interface, where the signaling message is sent by the user equipment to the RAN device through an access stratum (AS).

For example, a manner of receiving the signaling message in this embodiment is same as that in step S402, thus step S402 can be referred to and details will not be repeated herein.

In step S1004, generating a signaling response message according to the signaling message.

For example, in this embodiment, a manner of generating the signaling response message is same as that in step S804, hence step S804 can be referred to and details will not be repeated herein.

In another embodiment, the step of sending the signaling response message to the user equipment through the RAN device includes:

In step S1005, sending the signaling response message to the RAN device through the N2 interface, so that the signaling response message is sent to the user equipment through the AS of the RAN device.

For example, a manner of sending the signaling response message in this embodiment is same as that in step S403, thus step S403 can be referred to and details will not be repeated herein.

Optionally, before step S1005, the communication method further includes:
sending an acknowledgment character (ACK) to the RAN device, where the ACK indicates that the RAN device sent the signaling response message.

For example, a manner of sending the ACK in this embodiment is same as that in step S705, thus step S705 can be referred to and details will not be repeated herein.

In the above manner, the UE reports the communication status mode through the AS of the RAN device based on the signaling message, reports the communication status mode to the AMF network element through the N2 interface between the RAN device and the AMF network element, and the AMF network element feeds back corresponding a signaling response message to the UE based on the communication status mode, and establishes communication with the UE based on the communication status mode. Therefore, the UE reports communication availability of the UE to the AMF network element, to implement on-demand communication of the UE, and ambient Internet of Things communication in the mobile network is supported.

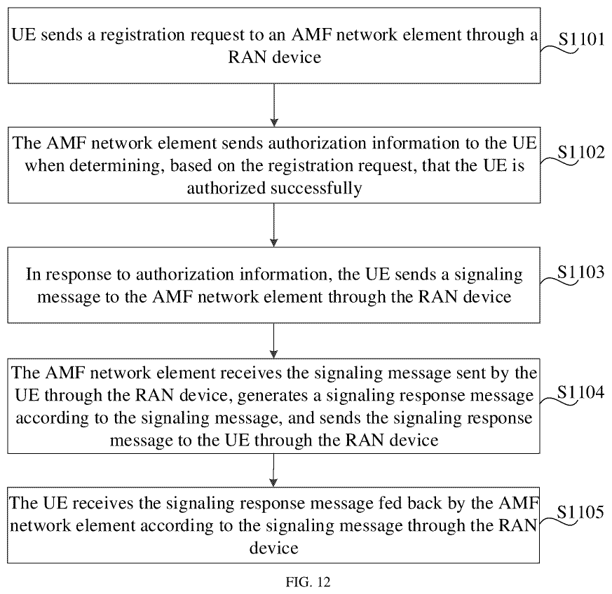

FIG. 12 is a flowchart of a communication method according to an example embodiment, as shown in FIG. 12, the method includes following steps.

In step S1101, a UE sends a registration request to an AMF network element through a RAN device.

For example, a manner for the UE to send the registration request in this embodiment is same as that in step S201, thus step S201 can be referred to and details will not be repeated herein.

In step S1102, the AMF network element sends authorization information to the UE when determining, based on the registration request, that the UE is authorized successfully.

For example, a manner for the AMF network element to send the authorization information in this embodiment is same as that in step S802, thus step S802 can be referred to and details will not be repeated herein.

In step S1103, in response to authorization information, the UE sends a signaling message to the AMF network element through the RAN device, where the signaling message includes a communication status mode of the user equipment.

For example, a manner for the UE to send the signaling message in this embodiment is same as that in step S202, thus step S202 can be referred to and details will not be repeated herein.

In step S1104, the AMF network element receives a signaling message sent by the UE through the RAN device, generates a signaling response message according to the signaling message, and sends the signaling response message to the UE through the RAN device.

For example, a manner for the AMF network element to send the signaling response message in this embodiment is same as that in step S203, thus step S203 can be referred to and details will not be repeated herein.

In step S1105, the UE receives the signaling response message fed back by the AMF network element according to the signaling message through the RAN device.

For example, a manner for the UE to receive the signaling response message in this embodiment is same as that in step S203, thus step S203 can be referred to and details will not be repeated herein.

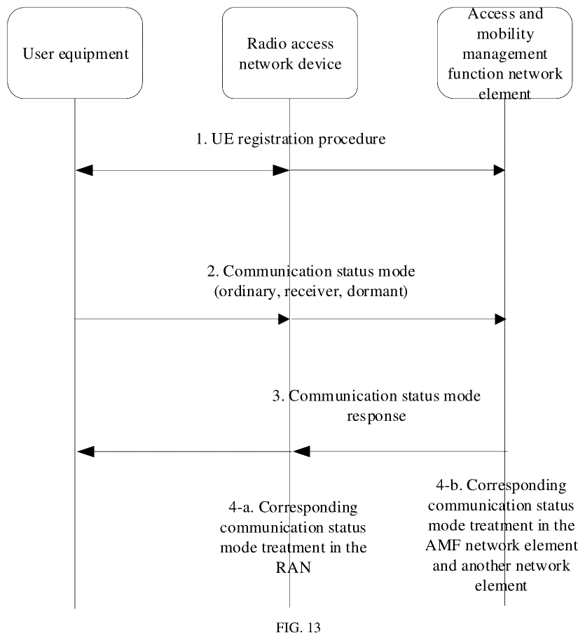

Optionally, in an embodiment, another communication method is provided. FIG. 13 is a flowchart of a communication method according to an example embodiment, as shown in FIG. 13, the method includes following steps.
1. The UE sends a UE registration request to an AMF network element through a RAN device, the AMF network element verifies legal identity of the UE according to related information in the registration request, and feeds back authorization information to the UE after the verification succeeds.
2. The UE sends a communication status mode to the AMF network element through the RAN device, where the communication status mode includes: an ordinary mode, a receiver mode, and a dormant mode.
3. The AMF network element feeds back corresponding response message to the UE according to the communication status mode through the RAN device, where the response message indicates the UE that the communication status mode has been received, and becomes effective for the UE.
4-a. The RAN device performs, after receiving the response message of the UE, corresponding communication processing on the UE according to the communication status mode of the UE.
4-b. The AMF network element and the other core network element perform, after sending the response message, corresponding communication processing on the UE based on the communication status mode of the UE.

In the above manner, the UE reports the communication status mode to the AMF network element through the signaling message, and the AMF network element feeds back corresponding a signaling response message to the UE according to the communication status mode, and establishes communication with the UE based on the communication status mode. Therefore, the UE reports communication availability of the UE to the AMF network element, to implement on-demand communication of the UE, and ambient Internet of Things communication in the mobile network is supported.

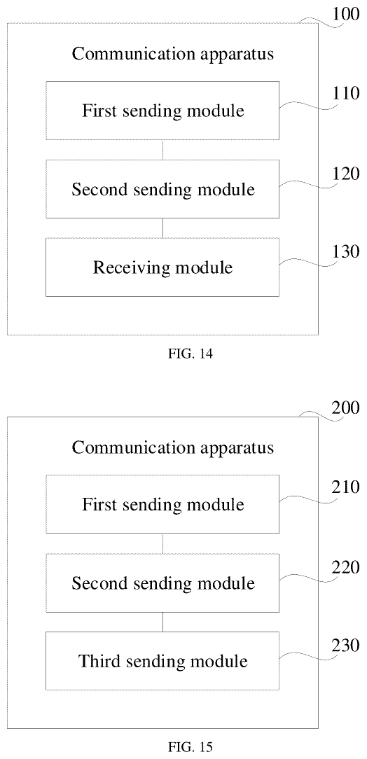

FIG. 14 is a block diagram of a communication apparatus according to an example embodiment. As shown in FIG. 14, the apparatus is applied to a UE, and the apparatus 100 includes: a first sending module 110, a second sending module 120, and a receiving module 130.

The first sending module 110 is configured to send a registration request to a network device.

The second sending module 120 is configured to, in response to authorization information fed back by the network device according to the registration request, send a signaling message to the network device, where the signaling message includes a communication status mode of the user equipment.

The receiving module 130 is configured to receive a signaling response message fed back by the network device according to the signaling message.

Optionally, the network device includes a RAN device and an AMF network element, and the second sending module 120 includes:
a sending sub-module, configured to send the signaling message to the AMF network element through the RAN device.

Optionally, the sending sub-module is configured to perform:
sending the signaling message to the AMF network element through a non-access stratum (NAS) of the RAN device.

Optionally, the sending sub-module is configured to:
sending the signaling message to the RAN device through an access stratum (AS) of the RAN device, so that the signaling message is sent to the AMF network element through the RAN device according to an N2 interface.

Optionally, the network device includes a RAN device and an AMF network element, and the receiving module 130 includes:
a receiving sub-unit, configured to receive the signaling response message fed back by the AMF network element according to the signaling message through the RAN device.

Optionally, the receiving sub-unit is configured to perform:
receiving the signaling response message fed back by the AMF network element according to the signaling message through a non-access stratum (NAS) of the RAN device, where the signaling response message is a NAS message.

Optionally, the receiving sub-unit is configured to perform:
receiving the signaling response message fed back by the AMF network element according to the signaling message through an access stratum (AS) of the RAN device, where the signaling response message is sent by the AMF network element to the RAN device through an N2 interface.

Optionally, the communication status mode includes an ordinary communication mode, a receiver communication mode, or a dormant communication mode.

Optionally, the registration request includes registration type information, user identifier information, and security parameter information.

Optionally, the user identifier information includes at least one of: a subscription concealed identifier (SUCI), a globally unique temporary user equipment identity (GUTI), or a permanent equipment identity (PEI).

FIG. 15 is a block diagram of a communication apparatus according to an example embodiment, as shown in FIG. 15, the apparatus is applied to a radio access network (RAN) device, and the apparatus 200 includes: a first sending module 210, a second sending module 220, a third sending module 230, a generating module 240, and a second sending module 250.

The first sending module 210 is configured to, in response to a registration request sent by a user equipment, send the registration request to an access and mobility management function (AMF) network element.

The second sending module 220 is configured to, in response to a signaling message sent by the user equipment upon receiving authorization information fed back by the AMF network element according to the registration request, send the signaling message to the AMF network element, where the signaling message includes a communication status mode of the user equipment.

The third sending module 230 is configured to, in response to a signaling response message fed back by the AMF network element according to the signaling message, send the signaling response message to the user equipment.

Optionally, the second sending module 220 is configured to perform:
sending the signaling message to the AMF network element through a non-access stratum (NAS) of the RAN device.

Optionally, the third sending module 230 is configured to perform:
in response to the signaling response message fed back by the AMF network element according to the signaling message through a non-access stratum (NAS) of the RAN device, sending the signaling response message to the user equipment through the NAS.

Optionally, the second sending module 220 is configured to perform:
receiving the signaling message sent by the user equipment, through an access stratum (AS) of the RAN device, upon receiving the authorization information fed back by the AMF network element according to the registration request; and sending the signaling message to the AMF network element through an N2 interface.

Optionally, the third sending module 230 includes:
a receiving sub-module, configured to receive a signaling response message fed back by an AMF network element through an N2 interface; and a sending sub-module, configured to send the signaling response message to the user equipment through the AS.

Optionally, the sending sub-module is configured to perform:
sending the signaling response message to the user equipment through the AS in response to an acknowledgement character (ACK) sent by the AMF network element.

Optionally, the apparatus 200 further includes an executing module, where the executing module is configured to perform:
in response to receiving the signaling response message, determining a communication manner between the RAN device and the user equipment.

Communication data is transmitted between the RAN device and the user equipment according to the communication manner.

Optionally, the communication status mode includes an ordinary communication mode, a receiver communication mode, or a dormant communication mode.

Optionally, the registration request includes registration type information, user identifier information, and security parameter information.

Optionally, the user identifier information includes at least one of: a subscription concealed identifier (SUCI), a globally unique temporary user equipment identity (GUTI), or a permanent equipment identity (PEI).

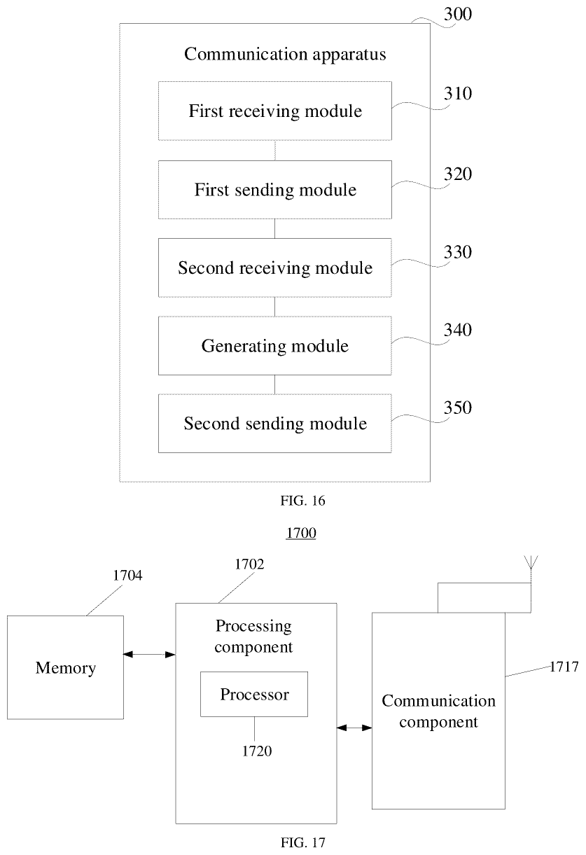

FIG. 16 is a block diagram of a communication apparatus according to an example embodiment, and as shown in FIG. 16, the apparatus is applied to an access and mobility management function (AMF) network element, and the apparatus 300 includes: a first receiving module 310, a first sending module 320, a second receiving module 330, a generating module 340, and a second sending module 350.

The first receiving module 310 is configured to receive a registration request sent by a user equipment through a radio access network (RAN) device.

The first sending module 320 is configured to send authorization information to the user equipment when determining that the user equipment is authorized successfully according to the registration request.

The second receiving module 330 is configured to receive a signaling message sent by the user equipment through the RAN device, where the signaling message includes a communication status mode of the user equipment.

The generating module 340 is configured to generate a signaling response message according to the signaling message.

The second sending module 350 is configured to send the signaling response message to the user equipment through the RAN device.

Optionally, the second receiving module 330 is configured to perform:
receiving the signaling message sent by the user equipment through a non-access stratum (NAS) of the RAN device.

Optionally, the second sending module 350 is configured to perform:
sending the signaling response message to the user equipment through the NAS of the RAN device.

Optionally, the second receiving module 330 is configured to perform:
receiving the signaling message sent by the RAN device through an N2 interface, where the signaling message is sent by the user equipment to the RAN device through an access stratum (AS).

Optionally, the second sending module 350 is configured to perform:
sending the signaling response message to the RAN device through the N2 interface, so that the signaling response message is sent to the user equipment through the AS of the RAN device.

Optionally, the apparatus 300 further includes a third sending module, where the third sending module is configured to perform:
sending an acknowledgment character (ACK) to the RAN device, where the ACK indicates that the RAN device sent the signaling response message.

Optionally, the apparatus 300 further includes an executing module, where the executing module is configured to perform:
determining a communication manner between the AMF network element and another core network node and the user equipment based on the signaling response message; and transmitting communication data between the AMF network element and the other core network node and the user equipment based on the communication manner.

Optionally, the communication status mode includes an ordinary communication mode, a receiver communication mode, or a dormant communication mode.

Optionally, the registration request includes registration type information, user identifier information, and security parameter information.

Optionally, the user identifier information includes at least one of: a subscription concealed identifier (SUCI), a globally unique temporary user equipment identity (GUTI), or a permanent equipment identity (PEI).

Regarding the apparatus in the above embodiments, a specific manner for each module to perform an operation has been described in detail in the embodiments related to the method, and will not be repeated in detail herein.

An embodiment of the present disclosure further provides a computer-readable storage medium, storing a computer program instruction, where when the program instruction is executed by a processor, steps of the communication method provided by the present disclosure is implemented.

An embodiment of the present disclosure further provides a user equipment, including: a processor; and a memory for storing a processor-executable instruction, where the processor is configured to perform steps of the communication method provided by the present disclosure when executing the executable instruction.

An embodiment of the present disclosure further provides a RAN device, including: a processor; and a memory for storing a processor-executable instruction, where the processor is configured to perform steps of the communication method provided by the present disclosure when executing the executable instruction.

An embodiment of the present disclosure further provides an AMF network element, including: a processor; and a memory for storing a processor-executable instruction, where the processor is configured to perform steps of the communication method provided by the present disclosure when executing the executable instruction.

FIG. 17 is a block diagram of a communication apparatus 1700 according to an example embodiment. For example, the apparatus 1700 may be a mobile phone, a computer, a digital broadcast terminal, a messaging device, a game console, a tablet device, a medical device, a fitness device, a personal digital assistant, or the like. Optionally, it may be any one of the foregoing UE, RAN device, and AMF network element.

Referring to FIG. 17, the apparatus 1700 may include one or more of following components: a processing component 1702, a memory 1704, and a communication component 1717.

The processing component 1702 generally controls overall operations of the apparatus 1700, such as operations associated with display, telephone calls, data communications, camera operations, and recording operations. The processing component 1702 may include one or more processors 1720 to execute instructions to perform all or part of the steps of the above method. In addition, the processing component 1702 may include one or more modules to facilitate interaction between the processing component 1702 and other components. For example, the processing component 1702 may include a multimedia module to facilitate interaction between the multimedia component and the processing component 1702.

The memory 1704 is configured to store various types of data to support operations at the apparatus 1700. Examples of such data include instructions for any application or method, contact data, phonebook data, messages, pictures, videos, etc., operating on the apparatus 1700. The memory 1704 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The communication component 1717 is configured to facilitate wired or wireless communication between the apparatus 1700 and other devices. The apparatus 1700 may access a wireless network based on a communication standard, such as WiFi, 2G, or 3G, or a combination thereof. In an example embodiment, the communication component 1717 receives a broadcast signal or broadcast related information from an external broadcast management system via a broadcast channel. In an example embodiment, the communication component 1717 further includes a near field communication (NFC) module to facilitate short-range communication. For example, NFC modules may be implemented based on radio frequency identification (RFID) technology, infrared data association (IrDA) technology, ultra-wideband (UWB) technology, Bluetooth (BT) technology, and other technologies.

In an example embodiment, the apparatus 1700 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the above communication method.

In an example embodiment, there is further provided a non-transitory computer-readable storage medium including an instruction, such as a memory 1704 including the instruction, where the instruction is executable by a processor 1720 of the apparatus 1700 to perform the above method. For example, the non-transitory computer-readable storage medium may be a ROM (read-only memory), a RAM (random access memory), CD-ROM (compact disc read-only memory), magnetic tape, floppy disk, optical data storage device, or the like.

The above apparatus may be an independent electronic device or a part of an independent electronic device, for example, in an embodiment, the apparatus may be an integrated circuit (IC) or a chip, where the integrated circuit may be an IC, or may be a set of ICs; and the chip may include but is not limited to the following types: a graphics processing unit (GPU), a central processing unit (CPU), a field programmable gate array (FPGA), a digital signal processor (DSP), an application specific integrated circuit (ASIC), a system on chip (SOC), or a system-on-chip. The integrated circuit or chip may be configured to execute an executable instruction (or code), to implement the above communication method. The executable instruction may be stored in the integrated circuit or the chip, or may be obtained from another apparatus or device, for example, the integrated circuit or the chip includes a processor, a memory, and an interface configured to communicate with another apparatus. The executable instruction may be stored in the processor, and when the executable instruction is executed by the processor, the above communication method is implemented; or the integrated circuit or chip may receive the executable instruction through the interface and transmit the executable instruction to the processor for execution, to implement the above communication method.

In another example embodiment, there is also provided a computer program product including a computer program executable by a programmable apparatus, the computer program having code portions for performing the communication method described above when executed by the programmable apparatus.

In another example embodiment, a chip is further provided, including a processor and an interface, where the processor is configured to read an instruction to perform the above communication method.

An embodiment of the present disclosure further provides a communication system, where the communication system includes the above UE, the RAN device, and the AMF network element.

In an embodiment, the UE may include the communication apparatus 100, the RAN device may include the communication apparatus 200, and the AMF network element may include the communication apparatus 300.

Other embodiments of the present disclosure will be readily apparent to those skilled in the art upon consideration of the specification and practice of the present disclosure. The present disclosure is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. A communication method, performed by a user equipment, comprising:
sending a registration request to a network device;
in response to authorization information fed back by the network device according to the registration request, sending a signaling message to the network device, wherein the signaling message comprises a communication status mode of the user equipment; and
receiving a signaling response message fed back by the network device according to the signaling message.

2. The method according to claim 1, wherein the communication status mode comprises: an ordinary communication mode, a receiver communication mode, or a dormant communication mode.

3. The method according to claim 1, wherein the network device comprises a radio access network (RAN) device and an access and mobility management function (AMF) network element, and sending the signaling message to the network device comprises:
sending the signaling message to the AMF network element through the RAN device.

4. The method according to claim 3, wherein sending the signaling message to the AMF network element through the RAN device comprises:
sending the signaling message to the AMF network element through a non-access stratum (NAS) of the RAN device.

5. The method according to claim 3, wherein sending the signaling message to the AMF network element through the RAN device comprises:
sending the signaling message to the RAN device through an access stratum (AS) of the RAN device, so that the signaling message is sent to the AMF network element through the RAN device according to an N2 interface.

6. The method according to claim 1, wherein the network device comprises a RAN device and an AMF network element, receiving the signaling response message fed back by the network device according to the signaling message comprises:
receiving the signaling response message fed back by the AMF network element according to the signaling message through the RAN device.

7. The method according to claim 6, wherein receiving the signaling response message fed back by the AMF network element according to the signaling message through the RAN device comprises:
receiving the signaling response message fed back by the AMF network element according to the signaling message through a non-access stratum (NAS) of the RAN device, wherein the signaling response message is a NAS message.

8. The method according to claim 6, wherein receiving the signaling response message fed back by the AMF network element according to the signaling message through the RAN device comprises:
receiving the signaling response message fed back by the AMF network element according to the signaling message through an access stratum (AS) of the RAN device, wherein the signaling response message is sent by the AMF network element to the RAN device through an N2 interface.

9. The method according to claim 1, wherein the registration request comprises registration type information, user identifier information, and security parameter information.

10. The method according to claim 9, wherein the user identifier information comprises at least one of: a subscription concealed identifier (SUCI), a globally unique temporary user equipment identity (GUTI), or a permanent equipment identity (PEI).

11. A communication method, performed by a radio access network (RAN), comprising:
in response to a registration request sent by a user equipment, sending the registration request to an access and mobility management function (AMF) network element;
in response to a signaling message sent by the user equipment upon receiving authorization information fed back by the AMF network element according to the registration request, sending the signaling message to the AMF network element, wherein the signaling message comprises a communication status mode of the user equipment; and
in response to a signaling response message fed back by the AMF network element according to the signaling message, sending the signaling response message to the user equipment.

12.-14. (canceled)

15. The method according to claim 11, wherein in response to the signaling message sent by the user equipment upon receiving the authorization information fed back by the AMF network element according to the registration request, sending the signaling message to the AMF network element comprises:
receiving the signaling message sent by the user equipment, through an access stratum (AS) of the RAN device, upon receiving the authorization information fed back by the AMF network element according to the registration request; and
sending the signaling message to the AMF network element through an N2 interface,
wherein in response to the signaling response message fed back by the AMF network element according to the signaling message, sending the signaling response message to the user equipment comprises:
receiving the signaling response message fed back by the AMF network element through the N2 interface; and
sending the signaling response message to the user equipment through the AS, wherein the sending comprises: sending the signaling response message to the user equipment through the AS in response to an acknowledgement character (ACK) sent by the AMF network element.

16. (canceled)

17. (canceled)

18. The method according to claim 11, further comprising:
in response to receiving the signaling response message, transmitting communication data between the RAN device and the user equipment.

19. The method according to claim 18, wherein the communication status mode comprises: an ordinary communication mode, a receiver communication mode, or a dormant communication mode; wherein in response to receiving the signaling response message, transmitting the communication data between the RAN device and the user equipment comprises:
determining a target communication status mode of the user equipment according to the signaling response message;
when the target communication status mode is an ordinary communication mode, performing at least one of receiving or sending the communication data with the user equipment;
when the target communication status mode is a receiver communication mode, sending the communication data with the user equipment; and
when the target communication status mode is a dormant communication mode, forbidding receiving and/or sending the communication data with the user equipment.

20. (canceled)

21. (canceled)

22. A communication method, performed by an access and mobility management function (AMF) network element, comprising:
receiving a registration request sent by a user equipment through a radio access network (RAN) device;
sending authorization information to the user equipment when determining that the user equipment is authorized successfully according to the registration request;
receiving a signaling message sent by the user equipment through the RAN device, wherein the signaling message comprises a communication status mode of the user equipment;
generating a signaling response message according to the signaling message; and
sending the signaling response message to the user equipment through the RAN device.

23.-28. (canceled)

29. The method according to claim 22, further comprising:
transmitting communication data between at least one of the AMF network element or another core network node and the user equipment according to the signaling response message.

30.-35. (canceled)

36. A user equipment, comprising:
a processor; and
a memory for storing a processor-executable instruction;
wherein the processor is configured to perform the method according to claim 1.

37. A radio access network (RAN) device, comprising:
a processor; and
a memory for storing a processor-executable instruction;
wherein the processor is configured to implement perform the method according to claim 11.

38. A access and mobility management function (AMF) network element, comprising:
a processor; and
a memory for storing a processor-executable instruction;
wherein the processor is configured to perform the method according to claim 22.

39. A non-transitory computer-readable storage medium, storing a computer program instruction that, when executed by a processor, causes the processor to perform the method according to claim 1.

40. (canceled)
